(19) United States
(12) Patent Application Publication
(10) Pub. No.: US 2014/0153771 A1
(43) Pub. Date: Jun. 5, 2014

(54) SUSPENSION SUPPORT STRUCTURE OF MULTI-FUNCTIONAL TYPE VIBRATION ACTUATOR

(71) Applicant: NAMIKI SEIMITSU HOUSEKI KABUSHIKI KAISHA, Tokyo (JP)

(72) Inventors: Kiyoshi OHASHI, Tokyo (JP); Yuichi HASHIMOTO, Tokyo (JP); Takayuki KUMAGAI, Tokyo (JP); Naoki TSUSHIMA, Tokyo (JP)

(73) Assignee: NAMIKI SEIMITSU HOUSEKI KABUSHIKI KAISHA, Tokyo (JP)

(21) Appl. No.: 14/093,295

(22) Filed: Nov. 29, 2013

(30) Foreign Application Priority Data
Nov. 30, 2012 (JP) 2012-262090

(51) Int. Cl. H04R 1/00

(52) U.S. Cl. CPC H04R 1/00
USPC 381/412

(57) ABSTRACT

Provided is a multi-functional type vibration actuator capable of stabilizing behavior of a magnetic circuit unit by preventing stress from concentrating on a connecting portion in a frame-shaped suspension. In the frame-shaped suspension, a plurality of support portions are formed to configure the connecting portion, and a strength of the connecting portion is improved by a suspension fixing portion and the support portions, thereby stabilizing the behavior of the magnetic circuit unit.

### CROSS-REFERENCE TO RELATED PATENT APPLICATIONS

This application claims the benefit of Japanese Patent Application No. 2012-262090, filed on Nov. 30, 2012, in the Japan Patent Office, the disclosure of which is incorporated herein in its entirety by reference.

### BACKGROUND OF THE INVENTION

1. Field of the Invention

The present invention relates to a multi-functional type vibration actuator having a dynamic structure, in which a sound reproduction unit is configured by attaching a diaphragm including a voice coil to a housing and a magnetic circuit unit having a magnet and a yoke is supported in the housing by using a frame-shaped suspension so as to dispose the voice coil in a magnetic gap formed by the magnetic circuit unit.

2. Description of the Related Art

Recently, a mobile communication device represented by a mobile phone has a sound reproduction function for using a receiving call sound and a vibration generation function for notifying receiving calls by using sensible vibrations, as a unit for notifying a user of a receiving call. A multi-functional type vibration actuator disclosed in Japanese Laid-open Patent Publication No. 2009-152924 (Patent Document 1) and Japanese Domestic Re-publication Patent No. 2008/093728 (Patent Document 2) is known as a component enabling the above functions by using a single component. According to the multi-functional type vibration actuator disclosed in the Patent Documents 1 and 2, a magnetic circuit unit that is an internal structure, as well as a housing, is formed as a polygonal shape. As such, a shape of the magnetic circuit unit matches to a shape of the housing, and thus, a vibration amount when sensible vibration is generated may be efficiently obtained. Moreover, in each of the Patent Documents 1 and 2, a suspension has an appropriate shape for the polygonal-shaped magnetic circuit unit to be attached thereto, and a suspension structure together with a support structure is specialized for the polygonal-shaped housing.

Even with the above advantages, according to the structures disclosed in the Patent Documents 1 and 2, there is a problem that, when the magnetic circuit unit vibrates, stress applied to a suspension arm is likely to be concentrated on a support portion that configures a connecting portion for connecting the suspension and the housing. This problem is due to the structure, including the support structures, which corresponds to the polygonal shape of the magnetic circuit unit. Thus, it is difficult to stabilize behavior of the magnetic circuit unit when sensible vibration is generated and external shock such as dropping occurs, and the support portion may be broken due to metal fatigue generated on the stress concentration portion.

(Patent Document 1) Japanese Laid-open Patent Publication No. 2009-152924

(Patent Document 2) Japanese Domestic Re-publication Patent No. 2008/093728

### SUMMARY OF THE INVENTION

The present invention provides a multi-functional type vibration actuator using a frame-shape suspension that is capable of stabilizing the behavior of a magnetic circuit unit when sensible vibration is generated or external shock such as dropping occurs, and at the same time, improving a durability of a support structure of the suspension.

According to an aspect of the present invention, there is provided a multi-functional type vibration actuator using a frame-shaped suspension, in which each of connecting portions between the frame-shaped suspension and a housing includes a plurality of supports. In more detail, each of connecting portions between the frame-shaped suspension and the housing has a structure in which only support portions are a plural quantity.

According to another aspect of the present invention, each of the connecting portions formed by the plurality of support portions is fixed by insert-molding to the housing.

### BRIEF DESCRIPTION OF THE DRAWINGS

The above and other features and advantages of the present invention will become more apparent by describing in detail exemplary embodiments thereof with reference to the attached drawings in which:

FIG. 1 is a perspective view of a multi-functional type vibration actuator according to an embodiment of the present invention;

FIG. 2 is an exploded perspective view of the multi-functional type vibration actuator according to the embodiment of the present invention;

FIG. 3 is side sectional view of the multi-functional type vibration actuator taken along line A-A′ and line B-B′ of FIG. 1;

FIG. 4 is a plan view of a suspension shown in FIG. 2;

FIG. 5 is a perspective view of a driving unit in a multi-functional type vibration actuator according to an embodiment of the present invention; and

FIG. 6 is a diagram showing a support structure of a magnetic circuit unit using a frame-shaped suspension according to an embodiment of the present invention.

### DETAILED DESCRIPTION OF THE INVENTION

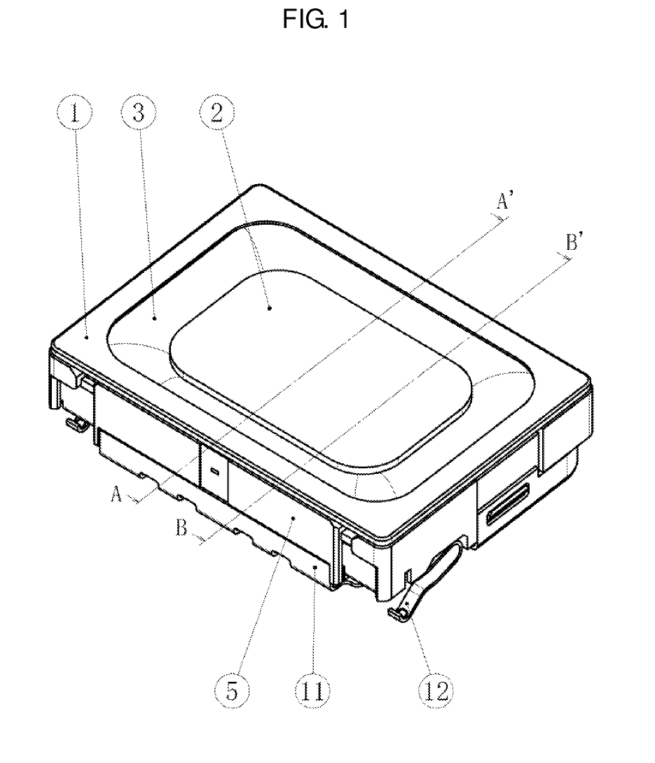

(Mode for Carrying Out the Invention) Hereinafter, embodiments of the present invention will be described below with reference to FIGS. 1 through 6.

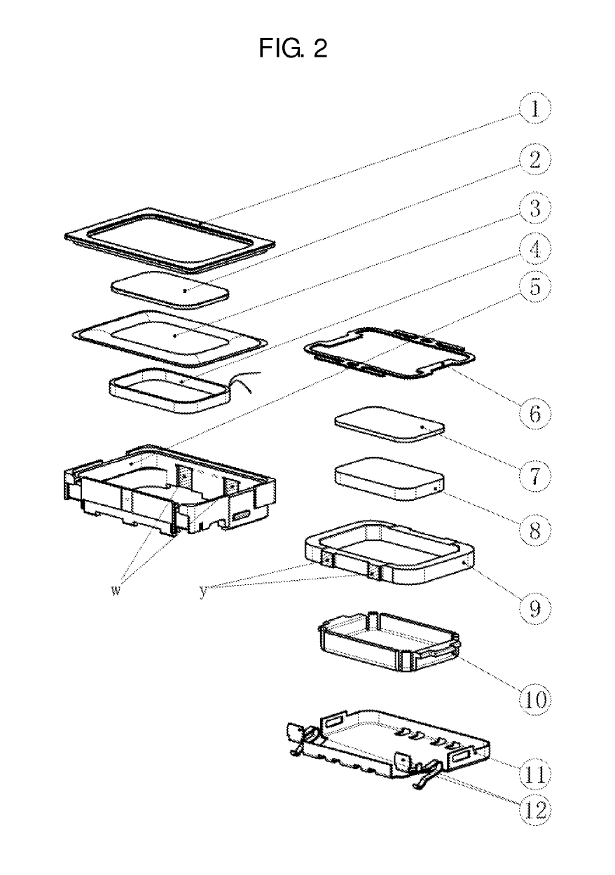

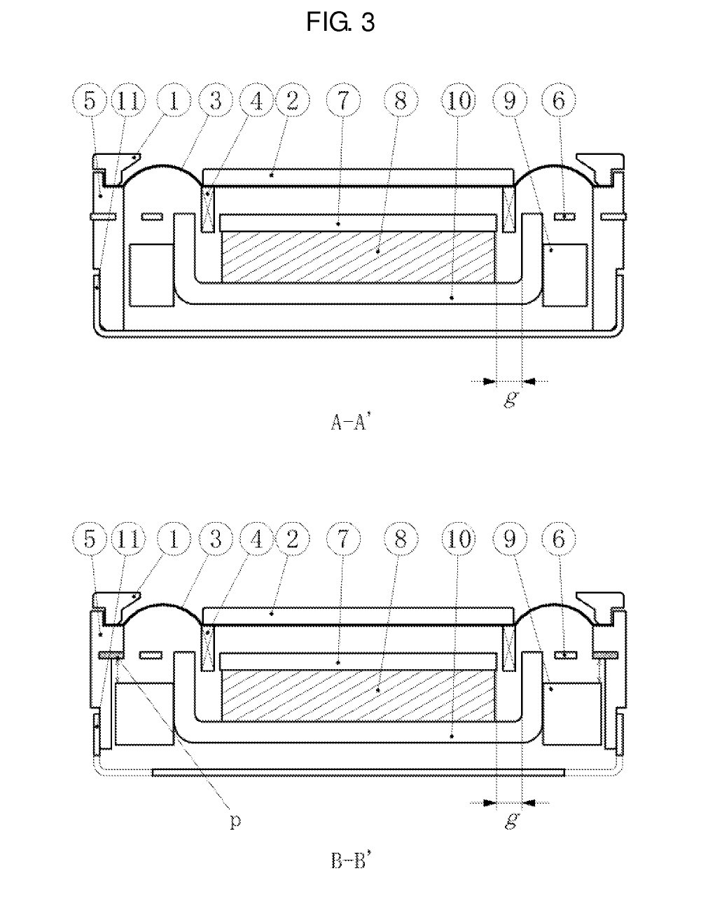

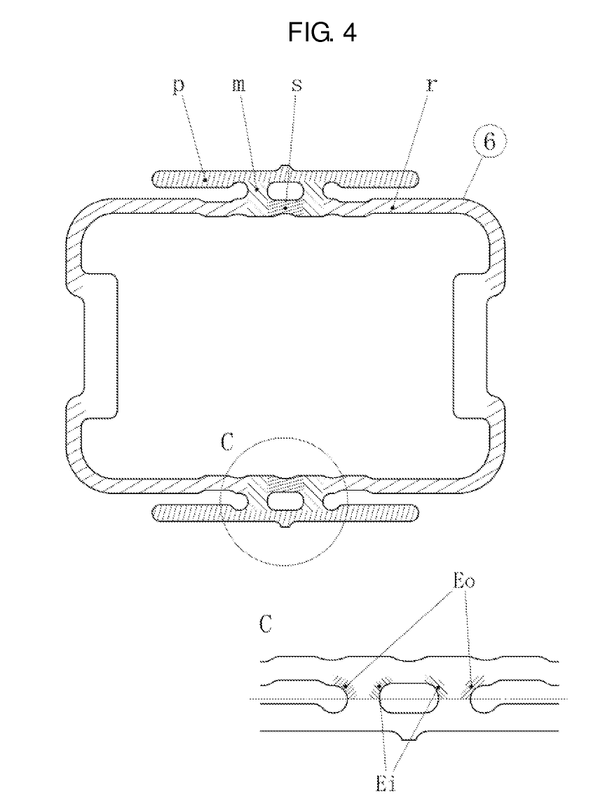

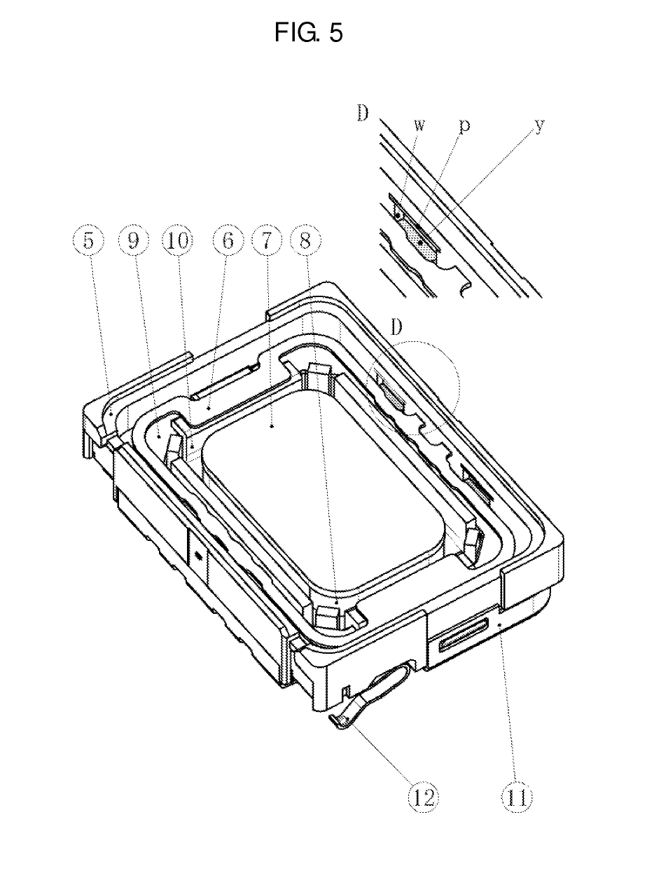

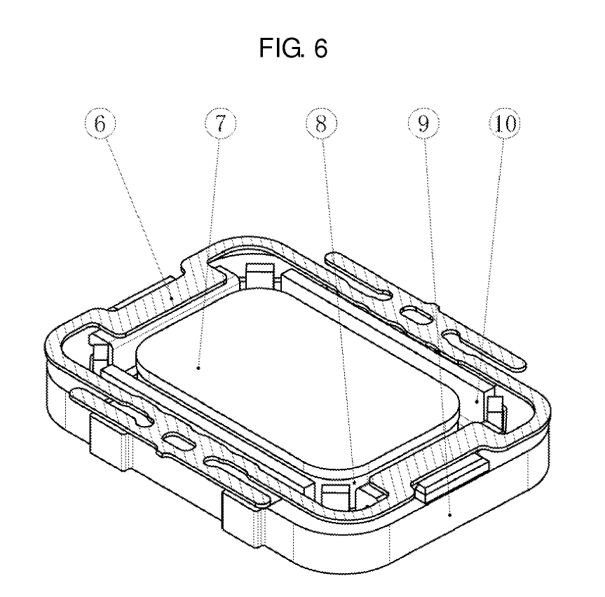

FIG. 1 is a perspective view of a multi-functional type vibration actuator according to an embodiment of the present invention, FIG. 2 is an exploded perspective view of the multi-functional type vibration actuator, FIG. 3 is side sectional view of the multi-functional vibration actuator taken along line A-A′ and line B-B′ of FIG. 1, FIG. 4 is a plan view of a suspension shown in FIG. 2, FIG. 5 is a perspective view of a driving portion showing a support structure of a magnetic circuit unit according to the present embodiment, and FIG. 6 is a diagram showing a support structure of the magnetic circuit unit using a frame-shaped suspension.

As shown in FIGS. 1, 2, and 5, the multi-functional type vibration actuator according to the present embodiment has a polygonal type driving structure having a square plane shape with respect to a housing 5, a voice coil 4, and a magnetic circuit unit, the magnetic circuit unit including a pole piece 7, a magnet 8, a yoke 10 and a weight 9. The multi-functional type vibration actuator of the present embodiment improves a space efficiency when being mounted on a case body such as a mobile phone by using the above driving structure. Also, since the voice coil 4 and the magnetic circuit unit are formed to have polygonal shapes, a volume of the magnetic circuit unit in the housing 5 may be ensured as much as possible so as to allow an increase in a vibration amount due to an increase of a weight of the magnetic circuit unit. Moreover, since the voice coil 4 is formed to have a polygonal shape, the voice coil 4 and the magnet 8 that are driving sources of a diaphragm 3 may be expanded, and thereby increasing a sound pressure when reproducing sound.

Also, as shown in FIGS. 2 and 3, the multi-functional type vibration actuator using in the present embodiment employs a dynamic structure which includes a sound reproduction unit formed by the diaphragm 3 and the voice coil 4, and the magnetic circuit unit fixed on an inner wall of the housing 5 via a frame-shaped suspension 6, and disposes the voice coil 4 in a magnetic gap g formed in the magnetic circuit unit. By using the above structure, the multi-functional type vibration actuator according to the present embodiment may adjust a frequency band of a signal input into the voice coil 4 so as to perform sound reproduction and sensible vibration generation in a single device. In more detail, the frequency band of an input signal to the voice coil 4 that is a driving source may be set to be adjacent to resonance frequency of each of the sound reproduction unit and the magnetic circuit unit, and thus, a sound output due to vibration of the sound reproduction unit and a sensible vibration output due to vibration of the magnetic circuit unit may be arbitrarily and distinctively used. In addition, the sound and the sensible vibration may be output at the same time by repeating each of the signals.

In addition to the above effects caused by the basic structure of the present invention, the present embodiment may obtain an independent effect by a support structure of the frame-shaped suspension 6 shown in FIGS. 2, 4, 5, and 6. That is, as shown in FIGS. 2, 4, 5, and 6, in the multi-functional type vibration actuator according to the present embodiment, a connecting portion between the frame-shaped suspension 6 and a fixing portion fixed on the inner wall of the housing 5 is formed by two support portions m. Therefore, in behavior of the magnetic circuit unit, a thickness of the support portion m and a length of an arm portion r may vary by appropriately setting a length of a beam portion s that is formed between the plurality of support portions m, and thereby adjusting vibration characteristics such as a resonance frequency when generating the sensible vibration. Also, according to the above structure, the connecting portion of the present embodiment has a structure, in which the support portions m function as fulcrums of each arm portion r and the fulcrums are connected to each other by using the suspension between the support portions m as a beam portion. Accordingly, when the magnetic circuit unit vibrates, warps generated in the arm portions r are applied to each other via the beam portion s, and the arm portions r interposing the connecting portion therebetween balance. Thus, stability of the magnetic circuit unit may be improved.

Also, since the beam portion s may increase a strength of each of the support portions m, as well as the stability of each of the support portions m, deformation of the connecting portion in a twisted direction, which is caused when the sensible vibration is generated or the external shock such as dropping occurs and is already restrained by the improved stability, may be further restrained. This effect may be obtained because each of the support portions m is reinforced by the beam portion s and the strength of the connecting portion is improved, in addition to the improved stability. Also, in the present embodiment, the beam portion s is formed between the support portions m, and thus, the connecting portion of the frame-shaped suspension 6 is formed as a rectangular structure formed by two support portions m and the beam portion s. Therefore, a load generated by generation of vibration and the external shock may be distributed through the entire connecting portion including internal corners Ei without concentrating on external corners Eo of the support portions m, and thus, durability of the connecting portion may be improved.

Also, as shown in FIGS. 3, 4, 5, and 6, a fixing portion p which is insert-molded to the inner wall of the housing 5 is formed as a integrally molded structure with the frame-shaped suspension 6 and the connecting portion. Therefore, the number of components may be reduced by the integral molding, a fixing strength may be improved and an assembling operation may be easily performed.

In addition to the above-described effects, the structure according to the present embodiment may obtain the same effects by changing the shape of the suspension in the conventional multi-functional type vibration actuator using the frame-shaped suspension. Accordingly, the durability and impact resistance may be improved and thereby increasing lifespan of the actuator without increasing the number of components, when compared with the conventional art.

As described above, by using the structure according to the present embodiment, the multi-functional type vibration actuator using the frame-shaped suspension capable of stabilizing the behavior of the magnetic circuit unit even with the external shock such as dropping and improving the durability of the support structure of the suspension may be provided.

By using the above structure, the multi-functional type vibration actuator according to the embodiment of the present invention may improve the durability of the connecting portion when the sensible vibration is generated and the external shock such as a drop occurs. This is because the connecting portion includes a plurality of support portions so as to allow distortion concentrated on the external corners of the connecting portion to be distributed to the internal corners of the connecting portion formed between the support portions. In more detail, according to the present invention, the connecting portion of the frame-shaped suspension has a structure, in which the corners are additionally formed between the support portions forming the connecting portion, as well as the improved strength. Accordingly, the stress, which is concentrated on the outer portion of the connecting portion by the single support portion when the vibration is generated and the external shock occurs, may be distributed into the internal portions of the connecting portion and thereby improving the durability of the connecting portion.

Also, since the connecting portion includes the plurality of support portions, the beam portion is added between the support portions. Thus, vibrations of the arm portions in which the support portions is used as fulcrums are applied to each other via the beam portion, and thus, the behavior of the magnetic circuit unit may be stabilized. Moreover, since the stability of each support portion is improved by the beam portion, the vibration of the magnetic circuit unit in the twisted direction caused when the vibration is generated and the external shock occurs may be restrained, and accordingly, reliability of the actuator may be improved. Also, since the above-described effects are obtained when the polygonal shape magnetic circuit structure is used, a contact between the voice coil and the magnetic circuit unit caused by an inclination of the magnetic circuit unit may be prevented, and performances does not degrade before and after generation of the vibration and the external shock.

Also, since the behavior of the magnetic circuit unit is stabilized by the beam portion and the deformation in the twisted direction is restrained by the support portions, the bias of the stress applied to each of the connecting portions may be reduced. Accordingly, the load applied to each of the connecting portion is reduced, in addition to the stress distribution due to the corners, and thus the durability of the actuator may be improved. Moreover, since the behavior of the magnetic circuit unit and the vibration characteristic such as the resonance frequency may be adjusted by the distance between the support portions, the actuator may be universally applied and the above-described effects may be obtained.

In addition to the above-described effects, according to the multi-functional type vibration actuator according to another embodiment of the present invention, the connecting portion is fixed by being integrally formed with the housing. As such, the number of components may be reduced by the integral forming, and the fixing strength may be improved and the assembling operation may be easily performed.

As described above, according to the embodiment of the present invention, the multi-functional type vibration actuator using the frame-shaped suspension capable of stabilizing the behavior of the magnetic circuit unit even with the generation of the sensible vibration and the external shock such as dropping, and improving the durability of the support structure of the suspension may be provided.

What is claimed is:

1. A multi-functional type vibration actuator comprising:
a sound reproduction unit which includes a diaphragm in which a voice coil is provided; and
a magnetic circuit unit which includes a yoke on which a magnet is provided, the magnetic circuit unit being supported by a frame-shaped suspension in a housing on which the sound reproduction unit is fixed,
wherein each of connecting portions between the frame-shaped suspension and the housing is formed by a plurality of supports.

2. The multi-functional type vibration actuator of claim 1, wherein each of the connecting portions is integrally formed with the housing.
